(19) United States
(12) Patent Application Publication
(10) Pub. No.: US 2018/0350581 A1
(43) Pub. Date: Dec. 6, 2018

(54) ION TRANSFER APPARATUS

(71) Applicant: SHIMADZU CORPORATION, Kyoto (JP)

(72) Inventors: Roger GILES, Manchester (GB); Alina GILES, Manchester (GB)

(73) Assignee: SHIMADZU CORPORATION, Kyoto (JP)

(21) Appl. No.: 15/778,787

(22) PCT Filed: Oct. 20, 2016
(86) PCT No.: PCT/EP2016/075274

§ 371 Date: May 24, 2018

(30) Foreign Application Priority Data
Nov. 27, 2015 (GB) 1521003.2
Nov. 27, 2015 (GB) 1521004.0

(51) Int. Cl. H01J 49/06; H01J 49/04; H01J 49/24; H01J 49/10

(52) U.S. Cl. CPC H01J 49/066; H01J 49/067; H01J 49/107; H01J 49/044; H01J 49/24; H01J 49/0404

(57) ABSTRACT

An ion transfer apparatus for transferring ions from a first pressure controlled chamber at a first pressure, which first pressure is lower than 10000 Pa, along a path to an adjacent second pressure controlled chamber at a second pressure that is lower than the first pressure. The ion transfer apparatus includes: the first pressure controlled chamber and the second pressure controlled chamber, wherein each pressure controlled chamber includes an ion inlet opening for receiving ions on the path and an ion outlet opening for outputting the ions on the path, wherein the ion outlet opening of the first pressure controlled chamber is in flow communication with the ion inlet opening of a the second pressure controlled chamber; and an RF focusing device configured to focus ions towards the path, the RF focusing device including a plurality of RF focusing electrodes, wherein each RF focusing electrode of the RF focusing device is configured to receive an RF voltage so as to produce an electric field that acts to focus ions towards the path, wherein each RF focusing electrode of the RF focusing device has a shape that extends circumferentially around the path. The first and second pressure controlled chambers each include RF focusing electrodes of the RF focusing device. Each RF focusing electrode of the RF focusing device has a thickness in the direction of the path and a thickness in a direction radial to the path that is less than a distance separating the RF focusing electrode from an adjacent RF focusing electrode of the RF focusing device.

### FIELD OF THE INVENTION

This invention relates to an ion transfer apparatus.

### BACKGROUND

Atmospheric pressure ionization has evolved into an indispensable analytical tool in mass spectrometry and applications in life sciences with a significant impact in areas spanning from drug discovery to protein structure and function as well as the emerging field of systems biology applied to biomedical scientific research. The advent of atmospheric pressure ionization and particularly electrospray enabled the analysis of intact macromolecular ions under native conditions which offers a wealth of information to many different disciplines of science. The generation of intact ionic species is accomplished at or near atmospheric pressure whereas the determination of molecular mass is accomplished at high vacuum. Therefore transfer efficiency of ions generated at high pressure toward consecutive regions of the mass spectrometer operated at reduced pressure is a critical parameter, which determines instrument performance in terms of sensitivity.

Electrospray ionization (“ESI”) is the prevailing method for generation of gas phase ions where ions in solution are sprayed typically under atmospheric pressure and in the presence of a strong electric field. Charged droplets released from the ESI emitter tip undergo a recurring process of evaporation and fission ultimately releasing ions sampled by an inlet capillary or other types of inlet apertures. The inlet aperture forms the interface of the instrument and represents a physical barrier between the high pressure ionization region and the fore vacuum region normally operated at 1 mbar background pressure. The size of the inlet aperture or capillary employed to admit ions in the fore vacuum is typically limited to ˜0.5 mm in diameter to establish the pressure differential necessary for the existing ion optical components to be operable and transport ions to subsequent lower pressure vacuum regions efficiently. Consequently, sampling efficiency of the spray containing charged droplets and bare ions using standard interface designs is limited to <1% and has a profound effect on instrument sensitivity.

The design of a high transmission interface for efficient transportation of ions from atmospheric pressure into the fore vacuum region of a mass spectrometer has grown into a challenging problem. One approach involves increasing pumping speed to accommodate relatively small increments in the size of the inlet aperture. Although increasing the inlet aperture appears a rather straight forward solution the inefficient heat transfer and incomplete desolvation of the electrospray droplets are not easily addressed. Furthermore, the cost related to the increased pumping speed becomes considerable. Efforts for improved ion transfer efficiency are also directed toward the development of novel ion optical devices operable at elevated pressure. The ion funnel has been operated successfully at pressures as high as 30 mbar, nevertheless increments in the size of the inlet aperture remain marginal. In yet another design of an interface a multi-inlet capillary configuration is implemented in an effort to sample a larger area of the electrospray plume. Using this type of a novel multi-inlet system enhanced transfer efficiency is claimed, however, the ion losses at the interface are still severe since the reduction in pressure from atmospheric to near or below 10 mbar requires the cross sectional area of the inlet to be kept small. Reducing pressure by approximately two orders of magnitude in a single step is inevitably associated with severe ion losses due to the narrow aperture or other types of multi-inlet system configurations employed. Indeed, these approaches do not address the underlying loss mechanisms arising from diffusion losses, space charge losses, and high gas velocity at the exit of the capillary/capillaries or skimmer. This latter problem can result in a high value for the turbulent velocity ratio (“TVR”) and the high gas speed prevents effective focusing via an electrical field.

In an entirely different approach a multi-chamber configuration has been disclosed to operate using enlarged apertures and where pressure is reduced progressively from the fore vacuum pressure of ˜5 mbar to regions of lower pressure. Over this pressure range ions can be guided by RF electrical fields. Whilst use of a series of vacuum regions to reduce pressure progressively may enhance ion transfer efficiency to the high vacuum region, it does not address the problem of the majority of the ions being lost at the interface where a single inlet aperture is employed to sustain a large drop in pressure which is typically from 1 bar down to 5 mbar.

U.S. Pat. No. 6,943,347 discloses a tube for accepting gas-phase ions and particles contained in a gas by allowing substantially all the gas-phase ions and gas from an ion source at or greater than atmospheric pressure to flow into the tube and be transferred to a lower pressure region. Transport and motion of the ions through the tube is determined by a combination of viscous forces exerted on the ions by the flowing gas molecules and electrostatic forces causing the motion of the ions through the tube and away from the walls of the tube. More specifically, the tube is made up of stratified elements, wherein DC potentials are applied to the elements so that the DC voltage on any element determines the electric potential experience by the ions as they pass through the tube. A precise electrical gradient is maintained along the length of the stratified tube to insure the transport of the ions.

WO2008055667 discloses a method of transporting gas and entrained ions between higher and lower pressure regions of a mass spectrometer comprises providing an ion transfer conduit 60 between the higher and lower pressure regions. The ion transfer conduit 60 includes an electrode assembly 300 which defines an ion transfer channel. The electrode assembly 300 has a first set of ring electrodes 305 of a first width D1, and a second set of ring electrodes of a second width D2 (=D1) and interleaved with the first ring electrodes 305. A DC voltage of magnitude V1 and a first polarity is supplied to the first ring electrodes 205 and a DC voltage of magnitude V2 which may be less than or equal to the magnitude of V1 but with an opposed polarity is applied to the second ring electrodes 310. The pressure of the ion transfer conduit 60 is controlled so as to maintain viscous flow of gas and ions within the ion transfer channel.

WO2009/030048 discloses a mass spectrometer including a plurality of guide stages for guiding ions between an ion source and an ion detector along a guide axis. Each of the guide stages is contained within one of a plurality of adjacent chambers. Pressure in each of the plurality of chambers is reduced downstream along the guide axis to guide ions along the axis. Each guide stage may further include a plurality of guide rods for producing a containment filed for containing ions about the guide axis, as they are guided to the detector.

U.S. Pat. No. 7,064,321 (also published as US2005/006579) discloses an ion funnel that screens ions from a gas stream flowing into a differential pump stage of a mass spectrometer, and transfers them to a subsequent differential pump stage. The ion funnel uses apertured diaphragms between which gas escapes easily. Holders for the apertured diaphragms are also provided that offer little resistance to the escaping gas while, at the same time, serving to feed the RF and DC voltages.

U.S. Pat. No. 8,610,054 discloses an ion analysis apparatus for conducting differential ion mobility analysis and mass analysis. In embodiments, the apparatus comprises a differential ion mobility device in a vacuum enclosure of a mass spectrometer, located prior to the mass analyser, wherein the pumping system of the apparatus is configured to provide an operating pressure of 0.005 kPa to 40 kPa for the differential ion mobility device, and wherein the apparatus includes a digital asymmetric waveform generator that provides a waveform of frequency of 50 kHz to 25 MHz. Examples demonstrate excellent resolving power and ion transmission. The ion mobility device can be a multipole, for example a 12-pole and radial ion focusing can be achieved by applying a quadrupole field to the device in addition to a dipole field.

US2009/127455 discloses ion guides for use in mass spectrometry and the analysis of chemical samples. The disclosure includes a method and apparatus for transporting ions from a first pressure region in a mass spectrometer to a second pressure region therein. More specifically, the disclosure provides a segmented ion funnel for more efficient use in mass spectrometry (particularly with ionization sources) to transport ions from the first pressure region to the second pressure region.

“A multicapillary inlet jet disruption electrodynamic ion funnel interface for improved sensitivity using atmospheric pressure ion sources”, Kim T, Tang K, Udseth H R, Smith R D/Anal Chem. 2001 Sep 1; 73(17):4162-70 discloses a multicapillary inlet jet disruption electrodynamic ion funnel interface for improved sensitivity using atmospheric pressure ion sources.

PCT/GB2015/051569 (currently unpublished, but relevant extracts from which are included in the present disclosure as an Annex) discloses an ion transfer apparatus comprising a plurality of pressure control chambers. This ion transfer apparatus was designed to provide an improved interface design capable of transferring ions into the fore vacuum region with greater efficiency while maintaining effective desolvation of charged droplets.

The present invention has been devised in light of the above considerations.

In some embodiments, the present invention may provide improvements to the ion transfer apparatus described in PCT/GB2015/051569 (currently unpublished, but relevant extracts from which are included in the present disclosure as an Annex).

### SUMMARY OF THE INVENTION

A first aspect of the invention may provide:
An ion transfer apparatus for transferring ions from a first pressure controlled chamber at a first pressure, which first pressure is lower than 10000 Pa, along a path to an adjacent second pressure controlled chamber at a second pressure that is lower than the first pressure, the ion transfer apparatus including:
the first pressure controlled chamber and the second pressure controlled chamber, wherein each pressure controlled chamber includes an ion inlet opening for receiving ions on the path and an ion outlet opening for outputting the ions on the path, wherein the ion outlet opening of the first pressure controlled chamber is in flow communication with the ion inlet opening of a the second pressure controlled chamber; and
an RF focusing device configured to focus ions towards the path, the RF focusing device including a plurality of RF focusing electrodes, wherein each RF focusing electrode of the RF focusing device is configured to receive an RF voltage so as to produce an electric field that acts to focus ions towards the path, wherein each RF focusing electrode of the RF focusing device has a shape that extends circumferentially around the path;
wherein the first and second pressure controlled chambers each include RF focusing electrodes of the RF focusing device;
wherein each RF focusing electrode of the RF focusing device has a thickness in the direction of the path and a thickness in a direction radial to the path that is less than a distance separating the RF focusing electrode from an adjacent RF focusing electrode of the RF focusing device.

By having such thicknesses, the RF focusing electrodes in the RF focusing device are able to focus ions against gas flow caused by the difference in pressure between the first and second pressure controlled chambers, whilst being adequately “transparent” to the gas flow.

An RF voltage may be understood as an alternating voltage that oscillates at a radio frequency.

As explained in more detail below, RF focusing electrodes have been found to be useful for pressure controlled chambers at a pressure that is lower than 10000 Pa.

Preferably, for each RF focusing electrode of the RF focusing device, the thickness of the RF focusing electrode in the direction of the path and the thickness of the RF focusing electrode in a direction radial to the path is less than half (more preferably less than a quarter) of a distance separating the RF focusing electrode from an adjacent RF focusing electrode of the RF focusing device.

Preferably, for each RF focusing electrode of the RF focusing device, the RF focusing electrode is separated from an adjacent RF focusing electrode of the focusing device by a distance that is between 3 and 7 times (more preferably between 3 times and 6 times) the thickness of the RF focusing electrode in the direction of the path.

For each RF focusing electrode, the RF focusing electrode may be separated from an adjacent RF focusing electrode of the RF focusing device by a distance that is between 0.5 mm and 3 mm (although smaller dimensions may be appropriate, e.g. in a multi-channel device).

Preferably, for each RF focusing electrode of the RF focusing device, the thickness of the RF focusing electrode in a direction radial to the path is between 0.5 and 1.5 times the thickness of the RF focusing electrode in the direction of the path.

For each RF focusing electrode, the thickness of the RF focusing electrode in the direction of the path may, for example, be 0.1 mm to 0.4 mm.

For each RF focusing electrode, the thickness of the RF focusing electrode in a direction radial to the path may, for example, be 0.1 mm to 0.4 mm.

Preferably, each RF focusing electrode of the RF focusing device has a shape that extends circumferentially around the path to form an aperture, wherein the aperture has an internal width (i.e. distance from one inwardly facing surface of the focusing electrode to another inwardly facing surface of the focusing electrode).

The internal width of an aperture of each RF focusing electrode (at its maximum extent) may be set to be large enough so that the RF focusing electrode can focus ions in the gas flow in the chamber in which the RF focusing electrode is located. This could be achieved, for example, by setting the internal width of the aperture to be the same as or larger than the width of the inlet opening of the chamber in which the RF focusing electrode is located.

Preferably, for each RF focusing electrode of the RF focusing device, the internal width of an aperture of the RF focusing electrode at its maximum extent is preferably between 1.5 and 10 times a distance separating the RF focusing electrode from an adjacent RF focusing electrode of the RF focusing device.

Preferably, for each RF focusing electrode of the RF focusing device, an aperture of the RF focusing electrode has an internal width that (e.g. at its maximum extent) is dependent on the position of the RF focusing electrode along the path, preferably such that the internal widths of the RF focusing electrodes reduce progressively with position along at least a portion of the path, see e.g. FIG. 5(b).

For each RF focusing electrode, an aperture of the RF focusing electrode may for example have an internal width that at its maximum extent is between 2 mm and 5 mm.

Preferably, for each RF focusing electrode of the RF focusing device, the RF focusing electrode has a circular (ring) shape that extends circumferentially around the path. However, it is also possible for each RF focusing electrode of the RF focusing device to have another shape that extends circumferentially around the path, which shape may for example be an oval or other curved shape, or indeed a square or other multi-sided shape. Thus, for the avoidance of any doubt, the term “circumferentially” should not be construed as requiring the electrodes to have a circular shape.

Preferably, for each RF focusing electrode of the RF focusing device, the RF focusing electrode is part of a (respective) metal sheet, e.g. a chemically etched metal sheet.

Each metal sheet may include an outer support structure connected to the RF focusing electrode that is part of the metal sheet via at least one supporting limb.

For each metal sheet, the/each supporting limb connected to the RF focusing electrode that is part of the metal sheet preferably has a thickness in a direction circumferential to the path that is no more than 3 times (more preferably no more than 2 times) the thickness of the RF focusing electrode in the direction of the path.

For each metal sheet, a distance from the outer support structure to the RF focusing electrode that is part of the metal sheet is, at its minimum extent, preferably greater than an internal width of an aperture of the RF focusing electrode at its maximum extent. This may be useful to provide space for gas flow out of the RF focusing electrodes in the RF focusing device.

Each RF focusing electrode of the RF focusing device may be configured to receive an RF voltage that is phase shifted with respect to an RF voltage received by an adjacent RF focusing electrode in the RF focusing device (the adjacent RF focusing electrode may be within the same pressure controlled chamber). For example, one or more pairs of adjacent RF focusing electrodes in the focusing device may be configured to receive RF voltages that are phase shifted by 180° with respect to each other.

The ion transfer device may include a wall separating the first chamber from the second chamber, wherein the wall includes the ion outlet opening of the first pressure controlled chamber. The wall or a portion of the wall that includes the ion outlet opening may be used as an RF focusing electrode of the RF focusing device, wherein the wall or portion of the wall is configured to receive an RF voltage so as to produce an electric field that acts to focus ions towards the path (see e.g. FIG. 5(b)).

The ion outlet opening of the first pressure controlled chamber may have an internal width that (at its maximum extent) is the same as or comparable to (e.g. within 10% of) the internal width (at its maximum extent) of at least one adjacent RF focusing electrode in the RF focusing device.

If the second chamber has a pressure of more than 1000 Pa, the ratio of the pressure in the first chamber to the pressure in the second chamber is preferably less than 2, more preferably less than 1.8.

If the second chamber has a pressure of less than 1000 Pa, the ratio of the pressure in the first chamber to the pressure in the second chamber is preferably less than 5 (more preferably less than 3).

The path in the first pressure controlled chamber may be inclined relative to the path in the second pressure controlled chamber.

Preferably, the ion transfer apparatus includes more than two pressure controlled chambers (i.e. not just the first and second pressure controlled chamber). The ion transfer apparatus may include 5 or more pressure controlled chambers, more preferably 8 or more pressure controlled chambers, more preferably 10 or more pressure controlled chambers. The number of pressure controlled chambers could be 20, 45 or even higher, depending on application requirements.

The ion transfer device may include more than two (e.g. 5 or more) pressure controlled chambers that each include RF focusing electrodes of the RF focusing device.

For the avoidance of any doubt, the ion transfer device may include one or more pressure controlled chambers that do not include RF focusing electrodes of the RF focusing device.

Any of the feature or any combination of features described herein in relation to the first and second pressure controlled chamber may apply to each adjacent pair of pressure controlled chambers in which both chambers include RF focusing electrodes of the RF focusing device,

Each pressure controlled chamber that includes RF focusing electrodes of the RF focusing device may be at a pressure that is lower than 10000 Pa. The ion transfer device may be for transferring ions from an ion mobility spectrometry (“IMS”) device or a differential mobility spectrometry (“DMS”) device at an IMS/DMS pressure, along a path towards a mass analyser at a mass analyser pressure that is lower than the IMS/DMS pressure.

IMS/DMS devices typically operate at a pressure that is less than 10000 Pa, so the IMS/DMS pressure may be less than 10000 Pa, e.g. 5000 Pa or less, e.g. in the region of 2000 Pa. The mass analyser pressure may be 1×10⁻² mbar or less.

If the ion transfer device is for transferring ions from an IMS or DMS device towards a mass analyser, then all pressure controlled chambers of the ion transfer device may include focusing electrodes of the focusing device.

Alternatively, the ion transfer apparatus may be for transferring ions from an ion source at an ion source pressure, which ion source pressure is greater than 500 mbar, along a path towards a mass analyser at a mass analyser pressure that is lower than the ion source pressure. In this case, the ion source pressure may be atmospheric pressure.

If the ion source pressure is atmospheric pressure, then the first pressure controlled chamber and the second pressure controlled chamber may be included in a subset of the pressure controlled chambers that have a pressure below a threshold value. The threshold value may be 10000 Pa or lower (e.g. in the region of 4000 Pa).

If the ion source pressure is atmospheric pressure, then the first and second pressure controlled chambers may be located nearer to the mass analyser than to the ion source.

The ion transfer device may include a plurality of pressure controlled chambers, wherein each pressure controlled chamber in the ion transfer apparatus includes an ion inlet opening for receiving ions from the ion source on the path and an ion outlet opening for outputting the ions on the path, wherein the first and second pressure controlled chambers are included in the plurality of pressure controlled chambers.

The plurality of pressure controlled chambers may be arranged in succession along the path from an initial pressure controlled chamber to a final pressure controlled chamber, wherein an ion outlet opening of each pressure controlled chamber other than the final pressure controlled chamber is in flow communication with the ion inlet opening of a successive adjacent pressure controlled chamber.

The ion transfer apparatus may be configured to have, in use, at least one pair of adjacent pressure controlled chambers for which a ratio of pressure in an upstream pressure controlled chamber to pressure in a downstream pressure controlled chamber (in the/each pair) is set such that there is substantially subsonic gas flow in the downstream pressure controlled chamber (in the/each pair).

In this way, it has been found that gas can be removed from the upstream pressure controlled chamber (in the/each pair) in a manner that permits the focusing of ions against the gas flow for ions having a wide range of mobility values in the downstream pressure controlled chamber. As discussed in more detail below, this can lead to advantages such as increased sensitivity and dynamic range of subsequent mass spectrometry analysis (highest to lowest ratio of sample ions concentration that may be submitted without saturation effects).

Note that the ratio of pressure in the upstream pressure controlled chamber to pressure in the downstream pressure controlled chamber (in the/each pair) will predominantly affect the gas flow in the downstream pressure controlled chamber, hence the reference to substantially subsonic gas flow in the downstream pressure controlled chamber in the above definition.

For the purposes of this disclosure, the term “subsonic gas flow” may be understood as describing a gas flow moving at a speed that is lower than the speed of sound.

A skilled person would appreciate that a substantially subsonic gas flow in a downstream pressure controlled chamber may contain a very small localised region around an inlet opening in which the gas flow has a speed that is at or exceeds the speed of sound. Such a region (if present) would typically have dimensions comparable to a width of the inlet opening. The presence or absence of a substantially subsonic gas flow in a downstream chamber can be inferred from the pressure ratio between an adjacent upstream chamber and the downstream chamber and/or simulation (suitable pressure ratios for achieving subsonic gas flow in a downstream chamber are defined below).

For the purposes of this disclosure, an “upstream” pressure controlled chamber in a pair of adjacent pressure controlled chambers is a pressure controlled chamber in the pair that is at a higher pressure than the other pressure controlled chamber in the pair. The “downstream” pressure controlled chamber in the pair is then the other pressure controlled chamber in the pair (that is at a lower pressure than the “upstream” pressure controlled chamber).

The initial pressure controlled chamber may be adjacent to and configured to receive ions from the ion source, e.g. through the ion inlet opening of the initial pressure controlled chamber.

The final pressure controlled chamber may be configured to transfer ions to the mass analyser, e.g. directly, or e.g. indirectly via one or more intervening components (e.g. a collision cell, a cooling cell).

If the ion source is present, the ion source pressure may be atmospheric pressure. The ion source may be an ESI ion source. The mass analyser pressure may be 1×10⁻² mbar or less.

For the/each pair of adjacent pressure controlled chambers (in the at least one pair of adjacent pressure controlled chambers for which a ratio of pressure in an upstream pressure controlled chamber to pressure in a downstream pressure controlled chamber is set such that there is substantially subsonic gas flow in the downstream pressure controlled chamber), the ratio of pressure in the upstream pressure controlled chamber to pressure in the downstream pressure controlled chamber (which ratio may be referred to as the jet pressure ratio, or “JPR”) may be 2 or less, may be 1.8 or less, may be 1.6 or less, may be 1.4 or less. The lower this ratio, the slower the movement of gas in the downstream pressure controlled chamber in the/each pair of adjacent pressure controlled chambers, and hence the easier it is to focus ions (e.g. electrostatically) against the gas flow in the downstream pressure controlled chamber.

A ratio of 1.8 or less is particularly preferred (in the at least one pair of adjacent pressure controlled chambers for which a ratio of pressure in an upstream pressure controlled chamber to pressure in a downstream pressure controlled chamber is set such that there is substantially subsonic gas flow in the downstream pressure controlled chamber), as this has been found to provide substantially subsonic gas flow in the downstream pressure controlled chamber (in the at least one pair of adjacent pressure controlled chambers).

A ratio of more than 1 is of course needed to provide gas flow from the upstream pressure controlled chamber to the downstream pressure controlled chamber in the/each pair of adjacent pressure controlled chambers. A ratio of 1.1 or more, or 1.2 or more may help to provide an ion transfer apparatus having a smaller number of pressure controlled chambers.

The ion transfer apparatus may include one or more gas pumps configured to pump gas out from pressure controlled chambers in the ion transfer apparatus such that, in use, the ion transfer apparatus has at least one pair of adjacent pressure controlled chambers (preferably a plurality of pairs of adjacent pressure controlled chambers) for which a predetermined ratio of pressure in an upstream pressure controlled chamber to pressure in a downstream pressure controlled chamber (in the/each pair) is set. As would be appreciated by a skilled person, pressure controlled chambers may be independently pumped using a respective pump configured to pump gas out from each chamber, or one or more pumps may each be configured to pump gas out from multiple chambers. Some possible pumping arrangements are set out in the enclosed Annex.

The ion transfer apparatus may include 5 or more pressure controlled chambers, more preferably 8 or more pressure controlled chambers, more preferably 10 or more pressure controlled chambers. The number of pressure controlled chambers could be 20, 45 or even higher, depending on application requirements.

Preferably, the ion transfer apparatus is configured to have, in use, a plurality of pairs of adjacent pressure controlled chambers for which a ratio of pressure in an upstream pressure controlled chamber to pressure in a downstream pressure controlled chamber (in each pair) is set such that there is substantially subsonic gas flow in the downstream pressure controlled chamber (in each pair).

The number of pairs of adjacent pressure controlled chambers for which an above-mentioned pressure ratio condition is met (e.g. for which a ratio of pressure in an upstream pressure controlled chamber to pressure in a downstream pressure controlled chamber is set such that there is substantially subsonic gas flow in the downstream pressure controlled chamber) may be the majority of pairs of adjacent pressure controlled chambers in the ion transfer apparatus.

However, the number of pairs of adjacent pressure controlled chambers for which an above-mentioned pressure ratio condition is met need not be all pairs of adjacent pressure controlled chambers in the ion transfer apparatus, since downstream pressure controlled chambers in which the pressure is very low (e.g. less than 1000 Pa, e.g. less than 500 Pa) may still be capable of providing effective focusing of ions against the gas flow due to the low pressure present in such chambers.

In some embodiments, all pairs of adjacent pressure controlled chambers in the ion transfer apparatus for which the downstream pressure controlled chamber is at a pressure above a threshold pressure meet an above-mentioned pressure ratio condition. This threshold may be 10000 Pa or more, more preferably 1000 Pa or more, more preferably 500 Pa or more.

The number of pairs of adjacent pressure controlled chambers for which an above-mentioned pressure ratio condition is met may, for example, be 5 or more, 10 or more, or 20 or more.

Preferably, each pressure controlled chamber in the ion transfer apparatus includes one or more focusing electrodes configured to produce an electric field that acts to focus ions towards the path (e.g. in a focusing region of the pressure controlled chamber). In this way, the focusing electrodes can keep ions on the path whilst gas is removed from the pressure controlled chambers.

Preferably, a subset (or all) of the pressure controlled chambers each include one or more DC focusing electrodes configured to receive one or more DC voltages so as to produce an electric field that acts to focus ions towards the path. A DC voltage may be understood as a non-alternating voltage (a voltage that does not alternate in time).

DC focusing electrodes have been found to be useful for pressure controlled chambers having a high pressure. The subset of the pressure controlled chambers that each include one or more DC focusing electrodes may therefore include those pressure controlled chambers having a pressure exceeding a threshold value. The threshold value may be 2000 Pa or higher, for example (e.g. in the region of 4000 Pa).

Preferably, a subset of the pressure controlled chambers each include one or more RF focusing electrodes, each RF focusing electrode being configured to receive an RF voltage so as to produce an electric field that acts to focus ions towards the path.

Each RF focusing electrode may be included in an RF focusing device as described above.

RF focusing electrodes have been found to be useful for pressure controlled chambers having a low pressure. The subset of the pressure controlled chambers that each include one or more RF focusing electrodes may therefore include those pressure controlled chambers having a pressure below a threshold value. The threshold value may be 10000 Pa or lower (e.g. in the region of 4000 Pa).

At least one (preferably a majority of, preferably each) pressure controlled chamber in the ion transfer apparatus in which DC focusing is employed, may include one or more ion defocusing regions in which ions are not focused towards the path. This allows the ion transfer apparatus to be configured with zero electric potential difference between adjacent chamber walls.

The location of the/each ion defocusing region may depend on the configuration of electrodes and voltages used.

The ion outlet opening of each pressure controlled chamber may be formed by an aperture in a tapering (e.g. conical shaped) element in a wall of the chamber. The tapering element may be oriented to increase in radius along the path.

The ion transfer apparatus may be for transferring ions from the ion source at the ion source pressure along a plurality of paths towards the mass analyser that is at the mass analyser pressure, wherein each pressure controlled chamber comprises a respective ion inlet opening for receiving ions from the ion source on each path and a respective ion outlet opening for outputting ions on each path. In this case, the ion transfer apparatus may be referred to as a “multi-channel” device.

The plurality of ion outlet openings of each pressure controlled chamber may be arranged along a circumferential (e.g. circular, oval, square or other multi-sided shape) path, since this may help reduce the impact of gas flow moving radially away from one ion outlet opening from disrupting the gas flow moving radially away from other ion outlet opening(s).

A second aspect of the invention may provide a mass spectrometer including an ion transfer apparatus according to the first aspect of the invention.

The mass spectrometer may include an ion mobility spectrometry (“IMS”) device or a differential mobility spectrometry (“DMS”) device configured to operate at an IMS/DMS pressure. The IMS/DMS pressure may be less than 10000 Pa, e.g. 5000 Pa or less, e.g. in the region of 2000 Pa.

The mass spectrometer may include an ion source configured to operate at an ion source pressure. The ion source pressure may be at atmospheric pressure. The ion source may be an electrospray ionisation (“ESI”) ion source.

For the avoidance of any doubt, the mass spectrometer may include an IMS device or DMS device in addition to an ion source.

The ion transfer apparatus included in the mass spectrometer may be configured to transfer ions from the ion source towards the mass analyser along the path or to transfer ions from an IMS/DMS device included in the mass spectrometer towards the mass analyser along the path.

The mass spectrometer may include a mass analyser configured to operate at a mass analyser pressure. The mass analyser pressure may be 1×10⁻² mbar or less.

A third aspect of the invention may provide a method of operating an ion transfer apparatus according to the first aspect of the invention or a method of operating a mass spectrometer according to the second aspect of the invention.

The method may include any optional feature described above in connection with the first/second aspect of the invention, or any method step corresponding to any such feature.

A fourth aspect of the invention may provide a method of making an ion transfer apparatus according to the first aspect of the invention or a mass spectrometer according to the second aspect of the invention.

The method of making may include forming each RF focusing electrode of the RF focusing device from a metal sheet, e.g. by chemical etching.

The invention also includes any combination of the aspects and preferred features described except where such a combination is clearly impermissible or expressly avoided.

References to “pressure” made herein, may be references to static pressure unless otherwise stated, as would be appreciated by a skilled person.

### BRIEF DESCRIPTION OF THE DRAWINGS

Examples of these proposals are discussed below, with reference to the accompanying drawings in which:

FIG. 1 shows a schematic diagram of an interface between a region at atmospheric pressure and one at low pressure comprising a plurality of chambers connected in series via sets of apertures, to provide a flow of gas from one chamber the next.

FIG. 2 shows a DSMC (direct simulation Monte-Carlo) simulation of the gas flow field for a series of pressure-controlled chambers, along with a table displaying data from the simulation.

FIG. 3(a)-(e) show possible electrode configurations for a focusing device (ion guide).

FIG. 4(a) shows a simulation ion trajectories passing through a pressure-controlled chamber with a focusing device (ion guides).

FIG. 4(b) shows a three-dimensional illustration of a focusing device (ion guides) in a pressure-controlled chamber.

FIG. 5(a) shows pictures of a gas transparent focusing device formed from a stack of chemically etched sheets of stainless steel with gradually reducing radius of apertures along the path and subsequently gold plated.

FIG. 5(b) shows a three-dimensional image of a focusing device used in a series of chambers, the first of which is pictured in FIG. 5(a).

FIG. 6(a) shows a table which gives the required number of apertures and length of the interface for a given aperture radius, assuming a gas acceptance flow rate of 460 mbar·l/s.

FIG. 6(b) shows a cross-sectional view as viewed from the front of an interface with sixteen apertures in each stage of the interface.

FIG. 6(c) shows a cross-sectional view as viewed from the side of an interface with sixteen apertures in each stage of the interface.

FIG. 7-FIG. 11 are drawings relating to an Annex, described in more detail below.

### DETAILED DESCRIPTION

In general, the following discussion describes examples of our proposals that relate generally to mass spectrometry and apparatuses and methods for use in mass spectrometry. In particular, though not exclusively, the examples relate to the transmission of gaseous ionic species generated in a region of relatively high or higher pressure (e.g. at or near atmospheric pressure) into a relatively lower or low pressure region.

The term “ion transfer device” and “interface” may be used interchangeably herein.

In the examples discussed below, an ion transfer apparatus has a focusing device (sometimes referred to herein as a “gas transparent ring guide” or “ion guide”) for transporting ions between pressure regions, via a plurality of chambers, and in which a gas jet flows through said chambers. The pressure in each chamber is set to control the jet velocity on the axis to be subsonic in all chambers. An RF focusing field formed within the ion guide for confining ions against the expanding gas jet. A method of construction for the above is also disclosed.

Beneficial effects of the ion transfer apparatus may include efficient and effective means to transport ions from a high pressure device, such as an ion mobility spectrometry (“IMS”) device or a differential mobility spectrometry (“DMS”) device operating at a typical pressure of 2000 Pa to lower pressure region, typically at ˜1 Pa.

In the examples discussed below, there is disclosed a gas transparent ring guide extending between multi pressure controlled chambers having a means to focus ions against the expanding gas jet thus providing a method of concentrating the ion flow with respect to the gas flow.

A starting point for the examples discussed below was a desire to improve the transport ions within the interface region of an API source efficiently, which interface region may include a differential mobility spectrometry (“DMS”) device e.g. according to U.S. Pat. No. 8,610,054, located in the interface region of a mass spectrometer. A DMS device typically operates in a pressure range 1500 to 5000 Pa. It is desirable that ions exiting the DMS device are transported from this relatively high pressure to a lower pressure region, typically <1 mbar with high efficiency and having a wide range of m/z. This was a motivating factor behind the present invention. At pressure <1 mbar traditional RF multipoles are effective.

The present inventors intended to develop a vacuum DMS device, and observed that:
Losses in prior art device may be due to high gas speed, and specifically supersonic speed. The gaseous ions entrained within a high speed gas flow are effectively bound to follow that flow and electrical fields are ineffective or partially ineffective to influence the ion flow in opposition to the gas flow. Furthermore high supersonic gas speed results in high turbulence, this turbulence may also reduce ion transmission.
This motivation was to find a method more effective than prior art devices to transport ions from a DMS device, e.g. as described in U.S. Pat. No. 8,610,054.
In support of the invention iterative simulations were undertaken to investigate gas dynamic effects in the interface and conditions preferred to reduce the gas velocity the separate the gas gradually from the main jet.

In devising the present invention, the present inventors were trying to achieve:
a) An increase in the ion current that may be transmitted from the DMS device.
b) An increase in the transmission efficiency of ions transmitted from the DMS device.

Potential advantages to a user may include:
a) A wider range of ion mass and mobility may be transmitted simultaneously through the device.
b) A lower level of concentration of sample ions may be analysed; that is a lower limit of detection (“LOD”) or instrument detection limit (“IDL”)

The studies referred to above led to the realisation that it is preferable to maintain the gas velocity subsonic, and allow expansion of the gas jet radially through the ion guide structure. It was found that the control of jet pressure ratio (JPR) between subsequent pressure controlled chambers allows for gradual and controlled separation of the ions from the gas flow, and further allows the use of RF electrical fields, i.e. pseudo potential to effectively confine ions towards the central axis of the device.

Thus the jet pressure ratio (JPR) may be defined to limit the gas speed. As a consequence one may define a sequence of pressure controlled chambers having small pressure drop between chambers so to transport ions from an initial (high) pressure to a final (low) pressure.

Here is a non-exhaustive list of what is considered to be ‘new and clever’ aspects of the present disclosure:
1. Imposed fixed pressure ratios to maintain the gas flow subsonic in a device for transporting ions
2. A focusing device, which can be referred to as a gas transparent ring guide (funnel, tunnel or other), implemented within a plurality of interconnected pressure controlled chambers. The ring guide is preferably made from multiple ring electrodes, where each ring electrodes and the chamber end walls are formed from thin metal sheets by the process of chemical etching.
3. A device for transporting ions comprising a plurality of interconnected pressure controlled chambers having a plurality of parallel channels.
4. The stacked ring guides located in adjacent pressure controlled chambers may be set at a small angle to each other.

Preferably:
The velocity of the gas jet is kept sufficiently slow through the transport device.
The jet pressure ratio between adjacent chambers is maintained within certain limits.
A geometry of the pressure controlled chambers and stacked ring guide is correctly defined.

As a result, it is preferred that:
A defined proportion of gas may be removed from the main jet at each pressure controlled chamber.
A sufficiently low outward radial flow from a gas jet is achieved to allow focusing of ions against the flow for ions having a wide range of mobility values.

Slow gas flow through the transport device prevents the formation of Mach regions and provides a reduction of the turbulence within the downstream jet. Turbulence in the gas jet may result in high ion losses through the device.

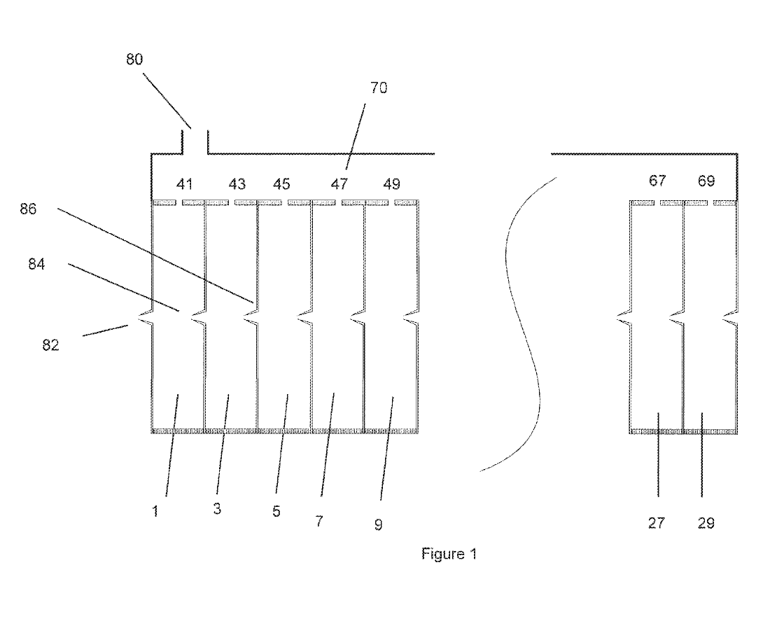

FIG. 1 shows a plurality of chambers (numbered 1 to 29). Chamber 1 has an entrance aperture 82 and exit aperture 84. Gas flows into chamber 1 from a higher pressure region (P <10 kPa). The pressure of gas in chamber 1 is lower and is determined by aperture 41. The pressure in chamber 3 is further lower than the pressure in chamber 1, and the pressure in chamber 5 is further lower than chamber 3. The ratio of the gas pressure between consecutive chambers is referred to as the jet pressure ratio (“JPR”). Gas flow enters chamber 1 as a confined jet and goes through the consecutive chambers from chamber 1 to chamber 29. The mass flow rate of jet is gradually reduced as the gas flows from chamber 1 towards chamber 29.

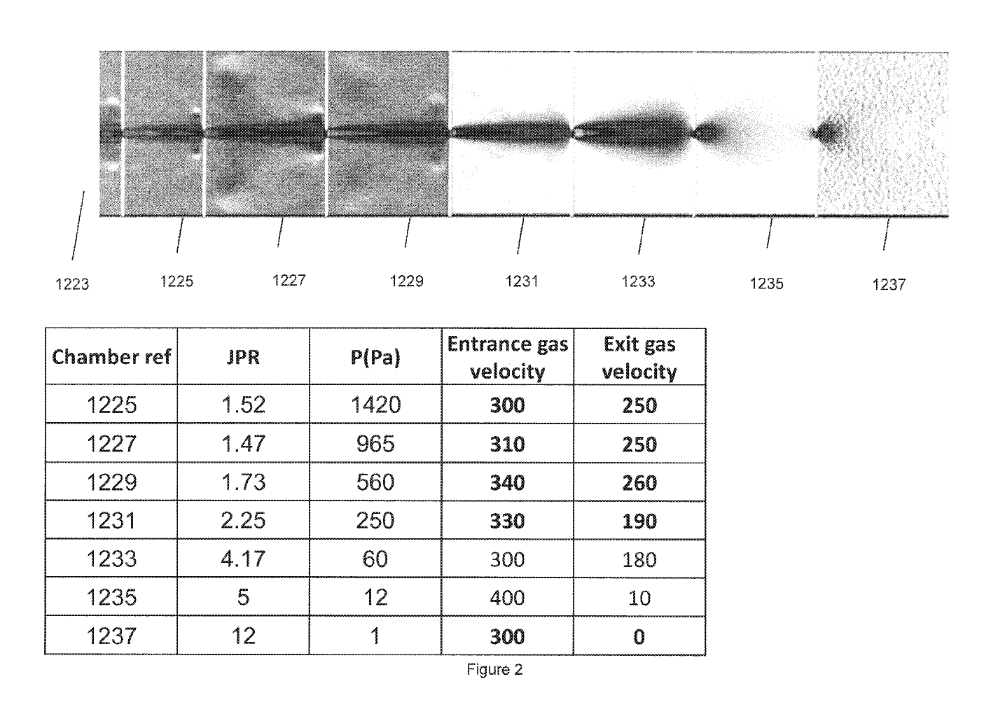

With reference to FIG. 2 there is shown sequence of 8 pressure controlled chambers (note that the pressures stated are the pressures for the downstream chamber corresponding to the stated pressure ratio). The chambers 1223 and 1225 have a length of 20 mm and chambers 1227 to 1237 all have length of 30 mm. In this embodiment the diameter of the apertures between chambers are all 2 mm.

Ion optic focusing elements with each chamber are not shown in FIG. 2. Also shown in FIG. 2, is the velocity of the gas jet calculated by the method of direct simulation Monte Carlo (“DSMC”). Also shown is jet pressure ratio (“JPR”) between chambers which is defined by the set pressure in the pressure control chambers. The JPR increases from 1.52 between the high pressure region and chamber 101 to 5 between chambers 1133 and 1135. This choice of JPR is sufficiently low to prevent the formation of a shock wave within each chamber and that the gas flow remains subsonic in all chambers but chamber 1235, which has a Mach number of 1.17. However, as the jet does not reach the chamber end wall and the pressure is already reduced to 12 Pa, there is no loss of ions.

In practice the JPR may be decided by the pumping speed applied to each pressure controlled chamber. Chambers may be pumped independently or may be pumped by a single pump or through chamber 1237. In the latter case the conductance between chambers may be adjusted to provide the required pressure in each chamber.

It can be seen from FIG. 2 that gas expands in each chamber in radial direction. In chambers 1223, 1225, 1227 and 229 there is a significant radially outwards flow on the surface of the chamber end walls. The proportion of gas flowing radially and not passing into the adjacent downstream chamber may be controlled by a combination of the JPR and the geometry of the chamber. More specifically the ratio of spacing between chamber walls, l and the diameter of the aperture, d, may be chosen to determine the proportion of gas to be removed in each chamber. In this embodiment the value of l/d is 10 and 15. Thus JPR may be used to vary the amount of gas removed in each chamber but the higher will be the ions losses.

The amount of gas removed in each chamber influences the strength of focusing needed to maintain ions closer to the axis of the gas jet.

With reference to the theory, the velocity of an ion in the gas media within the 1^{st} part of the device may be described by the following equation:

$$\vec{v} = \vec{u} + \frac{{10}^{5} {K}_{o} \vec{E}}{P} \qquad Equation 1$$

Kₒ is the ion mobility coefficient at pressure atmospheric pressure (1×10⁵ Pa) and P is the local gas pressure in Pascal. Eq. 1 holds in the region of continuum physics. A typical value for Kₒ in LCMS applications is of 0.0001 m²/(V·s)

At a pressure of 1×10³ Pa an electrical field of 2×10⁵ V/m field causes the ion to drift at a maximum velocity for the ion of 2,000 m/s, for this field is a maximum theoretical limit, in practice one is able to use significantly lower fields as ions would be caused to fragment at such field strength (the electrical field is so strong that heats up the ion causing fragmentation). A practical limit may be defined by the E/N value (Electrical field divided by the number density of the gas), usually measured in units of Townsend (Td), where 1 Td=1×10⁻²¹ V/m². Ions may fragment at E/N>˜100 to 300 Td. In this example of 1×10³ Pa (10 mbar) a maximum field strength is ˜5×10⁴ V/m, it corresponds to an ion drift velocity of (the ion having a reduced mobility value of 0.01 m²/Vs) of ˜200 m/s. This corresponds to Mach numbers of 0.55. A further restriction on the electrical field strength that may be employed for an interface to be employed as a general ion transmission device comes from the consideration that one must transmit ions having a range of mobility values. Typically in the range Kₒ≈6×10⁻⁵ to 3×10⁻⁴ m²/(V·s), that is a factor of 5. This imposes some further lowering of the upper limits of ion drift velocity and thus gas velocity that may be tolerated. Eq. 1 is a very simple expression employed to describe the ion drift velocity in ion mobility devices. To understand ion motion in the present device, a more detail analysis of the ion interface is insightful. Eq. 1 is more generally expressed as:

\vec{v}ⱼ=\vec{u}+Kⱼ\vec{E}−(1/ρⱼ)(Dⱼ grad ρⱼ) Equation 2

Where \vec{v}ⱼ (x,y,z,t) is the velocity of ion of type j at point x,y,z at time t, Kⱼ is the reduce mobility of ion of type j, Dⱼ(x,y,z,t) is the diffusion coefficient for the charged particles of type j which depends, in particular, on gas pressure and temperature at point x, y, z. \vec{u}(x, y, z) is the velocity of the neutral gas at point x, y, z and \vec{E}(x, y, z, t)=−grad U(x, y, z, t) is the electric field intensity where U(x, y, z, t) is the electric potential.

$$\begin{matrix}\frac{\partial {ρ}_{j}}{\partial t} + div ( {ρ}_{j} {\vec{v}}_{j} ) = 0 & Equation 3 \\ div ( {ɛɛ}_{0} \vec{E} ) = div ( - {ɛɛ}_{0} grad U ) = {Σρ}_{j} & Equation 4\end{matrix}$$

These equations may be solved as a system using numerical methods. Software was developed by the inventors for this purpose. Such a system of equations takes into account not only the gas flow and electrical field, but also the influence of diffusion and the total space charge density Σρⱼ. This system of equations has validity only in the continuum flow regime, and when the external variables change with respect to time and space coordinates only slowly. Furthermore, implicit in Equation 2 is that the ion velocity is constant, or rather changes slowly compared to the characteristic relaxation time of the ions. For the purposes of describing the current invention the system of equations is valid to a pressure range to ˜1000 Pa, and is valid assuming no shock waves in the gas flow are formed. Thus only valid for chambers 1225 and 1227.

In the example shown in FIG. 2, a gas jet continues to be established through chambers 1225, 1227, 1229, 1231, 1233 which as demonstrated by the DSMC calculation. The jet becomes progressively more divergent as the pressure is reduced and thus the JPR is increased. In pressure control chamber 1235 the jet no longer persist and the gas flow reduces practically to stand still at the midpoint of chamber 1235. The JPR between chamber 1233 and 1235 is 5 and the pressure in chamber 1235 is 12 Pa (0.12 mbar). The flow is divergent and gas speed reduces rapidly in all directions. The JPR between chamber 1235 and 1237 is 12 and the pressure in chamber 1237 is 1 Pa (0.01 mbar). The gas flowing into chambers 1235 and 1237 approaches that of a cosine distribution as expected for molecular flow conditions.

To study the transmission of ions through chambers 1223 to 1237 of the current embodiment, a particle tracking Monte Carlo method was used. The Monte Carlo simulation tracks individual ions using the gas flow field obtained by the direct simulation Monte Carlo (“DSMC”) method and calculation of the electrical field by a finite difference method. Considering the chamber 1225 of FIG. 2, the pressure is 1420 Pa giving a reduce mobility is 0.0071 m²/Vs (Kₒ=0.0001 m²/Vs). The drift velocity whilst maintaining the applied field within the low field limit (E/N<10 Td) provides an ion drift velocity of 25 ms⁻¹. The diffusion coefficient Dⱼ also scales with pressure, as Dⱼ may be expressed in terms of the reduce mobility (see Equation 5). Dₒ=2.6*10⁻⁶ [m²/s] for Kₒ=0.0001 [m²/Vs]. So in chamber 1225 diffusion is a factor 70 larger than at atmospheric pressure. DC fields can be used to focus ions towards the axis, but they cannot reduce the diffuse scattering of the ions that is pronounced in the lower pressure regions. However RF fields work well under low pressure providing the means to repel ions towards the axis, i.e. focusing them. Thus the present invention is most effective when RF fields are used. Additional DC focusing can optionally be used.

$$D = \frac{{k}_{b} T}{e} K \qquad Equation 5$$

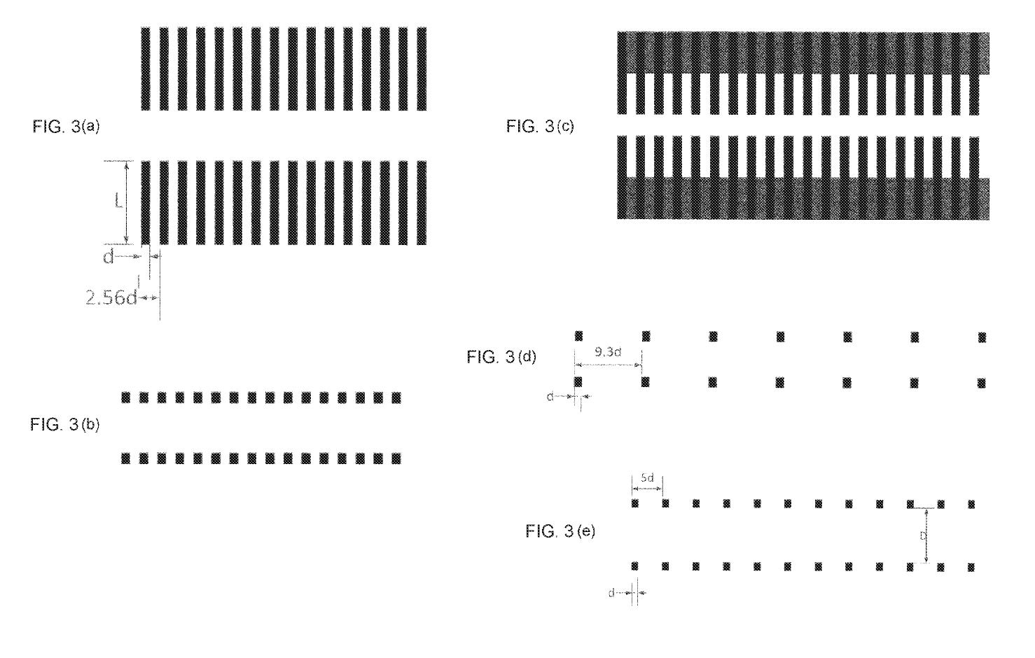

As found by the inventors, the key aspect of the stacked ring guide, when applied to an interface having a plurality of pressure controlled chambers, is the aspect of gas transparency. A gas transparent ion guide has a structure which is effective to allow gas to escape or flow out radially largely unhindered through the walls of the ion guide. This type of focusing device (“ion guide”) is described further with reference to FIG. 3. Structures (a) and (c) represent structures of the prior art. In (c) the electrodes are spaced by insulating rings, and it is clear that no gas is able to pass out radially and so all gas passing into the input will pass out the output, that is the gas throughput at the input is equal to that of the output. In the context of the multi-chamber interface, this causes a build-up of the gas pressure at the exit aperture of the chamber a high radial flow at the chamber end wall and consequently high ions losses. Although structure (a), also described in the prior art, provides gaps between the electrodes, a study of the gas dynamics shows that this structure is equivalent to (c) and no significant amount of gas is able to pass out of the structure radially. Note that structure (a) is characterised by L>>d, and d˜f (f is the electrode spacing). Here L is the thickness of the electrodes in radial direction, d is thickness of the electrodes in axial direction. In FIG. 3, Structure (a) f=2.65 d, the gap between the electrode is thus 1.65d. Structure (b) is an improvement on (a) in respect of the expected gas transparency. In thus structure L=d and f=2.65 d. However, this structure also has limited gas transparency and is not a preferred embodiment. Structure (d) is characterised by the L=d, and the f>>d, it is drawn as 9.3 d. This structure has very good gas transparency, but due to the large spacing the pseudo potential between the rings created by application of RF voltage to the rings, will not retain the ions inside the structure. Structure (e) provides L=d and f=5d and D=2f, where D is the inner diameter of the structure and represents a preferred embodiment for the stacked ring guide. Structure (e) will provide both transparency to the gas, also confine ions by the pseudo potential. The diameter of the D is preferably chosen to be comparable to the diameter of the gas jet.

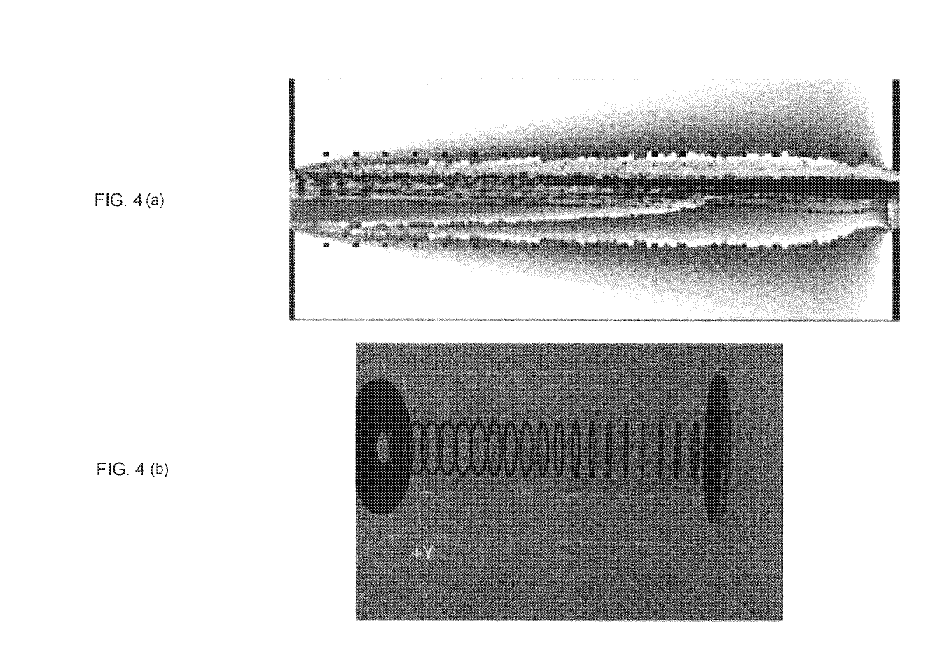

An ion simulation of a preferred embodiment is shown in FIG. 4, which shows ion trajectories passing through chamber 1225 (see FIG. 2). In this simulation L=d=0.2 mm, f=1 mm and D=3 mm. The trajectories are plotted in the mass range m/z=200 Th to 1000 Th, with the collision cross section adjusted appropriately to the mass of the ions. The simulation shows there are no ions losses, all ions entering through the input aperture to chamber 1225 pass through the exit aperture, the transmission is 100%. Similar simulations, performed for chambers 1227, 1229, 1231, 1235 and 1237, show the same result of 100% ion transmission. As the pressure is reduced through chambers 1225 to 1237, the RF focusing becomes more effective at moving ions against the radial gas flow. As ions approach the exit, they are converged by the radially inward gas flow.

The focusing device is preferably constructed from chemically etched sheets of stainless steel which provides a fine pitch of the ring guide and simultaneously provides high gas transparency. The transparent ring ion guide may have an ID comparable to the pressure limiting apertures used for separating the pressure controlled chambers.

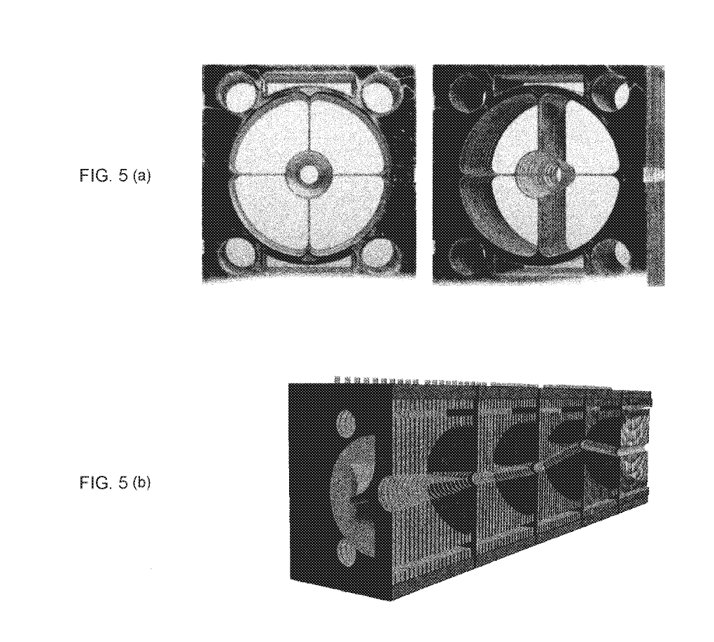

A device according to the current invention formed from chemically etched sheets is shown in FIG. 5(a) and FIG. 5(b). FIG. 5(a) shows a focusing device, which may be referred to as a gas transparent ion funnel, formed from a stack of chemically etched sheets of stainless steel and subsequently gold plated. This is shown as the 1^{st} chamber of the focusing device (“ion guide”) in FIG. 5(b). The same method of construction is used to form further chambers of the device shown here as transparent stacked ring ion tunnels in each of the 5 chambers. The same construction methods may be used to form devices having multiple channels and or converging channels, i.e. several channels converging to a single channel.

The transparent stacked ring ion guide transports ions through several pressure controlled chambers. It is not necessary to provide pumping to each of the pressure controlled chambers as is required by U.S. Pat. No. 7,064,321B, but in embodiments the conductance between chambers may be adjusted by setting a conductance pathway be chambers. Pumping arrangements as discussed in PCT/GB2015/051569 (currently unpublished, but relevant extracts from which are included in the present disclosure as an Annex) are applicable.

In other preferred embodiments the axis of (i.e. the path towards which ions as focused by) the stacked ring guides may be set at an angle to each other to as shown by FIG. 5(b). This provides a further means to control gas separation from ions and also provides a method to remove fast neutral particles from the gas jet. Fast neutral particles may take the form of solvent droplets originating in the ESI spray plume that have not fully evaporated. These droplets are harmful to the limit of detections of the downstream mass analyser, and are preferably removed in the ion transport channel.

Ions may be supplied to the device from an ESI probe according to the prior art for creating a plume or spray of charged droplets containing sample ions, and including a means to evaporate the droplets to generate gaseous sample ions at the ion source region (usually operating under atmospheric pressure) or within an upstream interface according to the prior art, and a means for transporting sample ions to a differential mobility device according to prior art.

The described ion transfer device has general application as an ion transport device directed to transporting ions efficiently between pressure regions, where the gas flow is reduced within each stage. For example, it may be employed instead of an ion funnel or other stacked ring device, and may operate with improved efficiency and at higher pressure than the prior art devices. It may be used to transport ions from analytical devices which operate at pressures higher than traditional prior art devices that work effectively at 1 Pa or lower. Analytical devices are DMS and IMS operating within intermediate pressure, typically 1000 to 10000 Pa and within the interface region of an atmospheric pressure ionisation source of a mass spectrometer.

The following represents preferred features/conditions/operating ranges for implementing the present proposals (of course, these values/ranges may depend upon individual application requirements and size constraints):
JPR profile The JPR profile set out above is only one example. Many other examples may be considered provided that the gas jet velocity does not exceed Mach 1, and is preferably significantly less than Mach 1. Preferably, the pressure in the pressure control chamber does not fall below 100 Pa.
% gas removed: The gas flow removed from the gas jet per chamber may be in the range 5% to 50%.
Chamber geometry: The ratio of spacing between chamber walls, l and the diameter of the aperture, h, in the end walls of the chamber may be chosen to determine the proportion of gas to be removed in each chamber. Generally the value of l/h may vary from 5 to 50. This ratio may be constant throughout the device, or most generally may be varied along the device.
Diameter h: h may be typically in the range 0.1 mm to 5 mm.
Focusing: The device may have RF focusing only or DC and RF focusing.
Pressure range: The device is useful for transporting ions from high pressure to low pressure Typically the upper pressure range is 10000 Pa and the lower pressure limit is 1 Pa.
Gas transparent stacked ring device: L=0.5 d to 1.5 d and f=3 d to 6 d and D=1.5 f to 10 f.

### Multi-Channel Device (“Parallel Embodiment”):

Prior discussion was limited to an interface with a single channel (single path). A single channel system however suffers a number of restrictions. In order to achieve enhanced gas throughput one must have set apertures as large as possible. However, as has been described this determines the length of the device. In preferred embodiments this requires a device length that is too long for some potential applications.

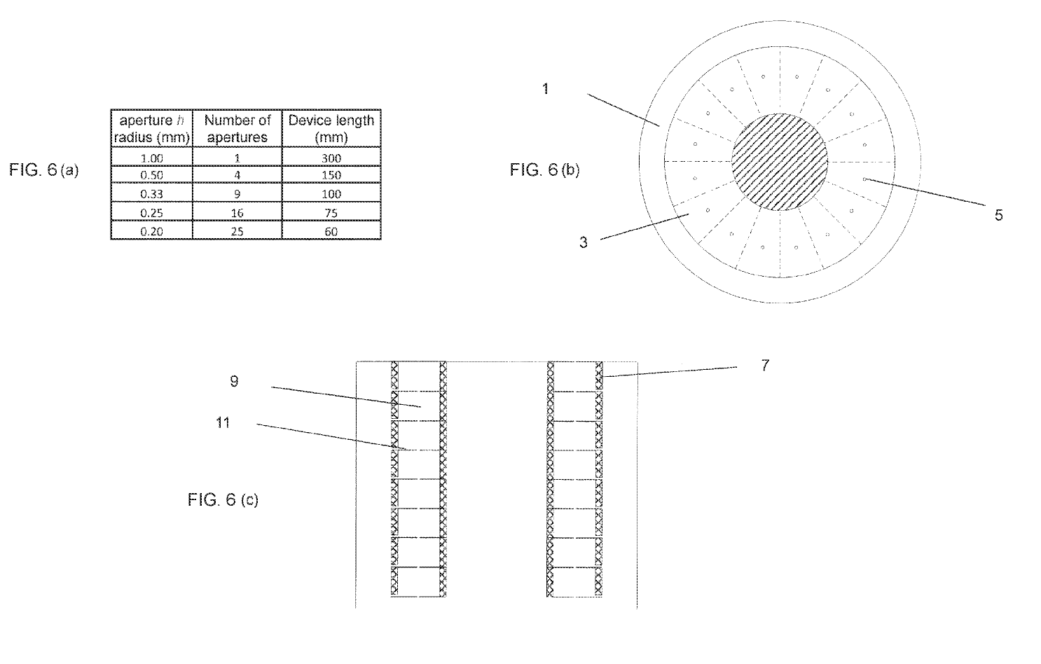

The present disclosure allows for increases in gas throughput or intake compared to prior art devices, and is limited only by the investment in the pumping system and the size of the device. The diameter of the aperture h in each pressure controlled chamber in turn determines l the spacing between chamber walls. Thus simply increasing the diameter h of a single aperture will lead to a device that is longer than to be viable for use in some commercial LCMS system. Although feasible for high end bespoke instrumentation, ultimately the length may become a disadvantage in commercial implementation. An effective alternative is a multiple chamber (“MC”) interface having a number of parallel channels. An MC interface having a plurality of channels thus falls within the scope of the invention. As the size of the gas jet scales with the diameter of the inlet aperture, the overall length of the structure may be scaled with aperture size. Gas throughput may be maintained by increasing the number of apertures. FIG. 6(a) gives the radius and number of apertures assuming the device required 10 chambers to deliver ions between from the initial to final pressure. For example a reduction of the apertures to radii from 1 mm to 0.2 mm would require 25 parallel channels. The length of the device would reduce from 300 mm to 60 mm. Such a parallel embodiment of the MC interface would provide acceptable dimension to the application of commercial LCMS instrumentation and could feasibly be produced from a stack of chemically etched sheets. An example of a structure having a plurality of chambers is shown in FIG. 6(b) and FIG. 6(c). FIG. 6(b) shows the cross sectional view as viewed from the front of the device. FIG. 6(c) shows the cross sectional view as viewed from the side of the device, only a proportion of 45 pressure controlled chambers are shown. The device shown has 16 apertures 5, in each stage of the device. The pressure control chamber is divided into equal 16 segments 3, each of which is in fluid communication with pumped region 1. Each pressure controlled chamber 9, is formed from conducting sheets 11, which form the chamber endplates and insulating spacers 9. The insulating spacers have apertures to determine the pressure in the pressure controlled chambers. Optionally the endplates may have formed grooved for guiding the gas to the exit apertures, e.g. as described in PCT/GB2015/051569 (currently unpublished, but relevant extracts from which are included in the present disclosure as an Annex). The chambers may contain focusing elements in each chamber as described above. Optionally the endplates may be formed from PCBs and may be used to deliver voltages to the lens electrodes. These are not shown in FIG. 6. An additional advantage of the parallel embodiment of the MC device is that focusing may be achieved with reduced voltages applied to the electrodes.

The apparatus as described above is intended for use in any LCMS instrumentation, it could be fitted to any instrument with hardware modifications. It is also applicable to any ionisation method taking place at atmospheric pressure such as nanospray, direct ionisation methods, AP-MALDI. It is expected that the device would be used for next generation instrument only, although a factory retrofit would in principle be possible.

When used in this specification and claims, the terms “comprises” and “comprising”, “including” and variations thereof mean that the specified features, steps or integers are included. The terms are not to be interpreted to exclude the possibility of other features, steps or integers being present.

The features disclosed in the foregoing description, or in the following claims, or in the accompanying drawings, expressed in their specific forms or in terms of a means for performing the disclosed function, or a method or process for obtaining the disclosed results, as appropriate, may, separately, or in any combination of such features, be utilised for realising the invention in diverse forms thereof.

While the invention has been described in conjunction with the exemplary embodiments described above, many equivalent modifications and variations will be apparent to those skilled in the art when given this disclosure. Accordingly, the exemplary embodiments of the invention set forth above are considered to be illustrative and not limiting. Various changes to the described embodiments may be made without departing from the spirit and scope of the invention.

For the avoidance of any doubt, any theoretical explanations provided herein are provided for the purposes of improving the understanding of a reader. The inventors do not wish to be bound by any of these theoretical explanations.

All references referred to above are hereby incorporated by reference.

### ANNEX—EXTRACTS FROM PCT/GB2015/051569

These extracts from PCT/GB2015/051569 are included to provide background as regards the possible construction and operation of an ion transfer apparatus including a plurality of pressure-control chambers.

In this Annex, the figures have been renumbered to avoid conflict with the other figures in this patent application, and the claims have been relabelled as “statements” to avoid confusion with the claims of this patent application.

Examples of preferred embodiments of the invention will now be described for the purposes of illustrating the invention in some implementations. It should be understood that the invention is not limited to any one of these embodiments.

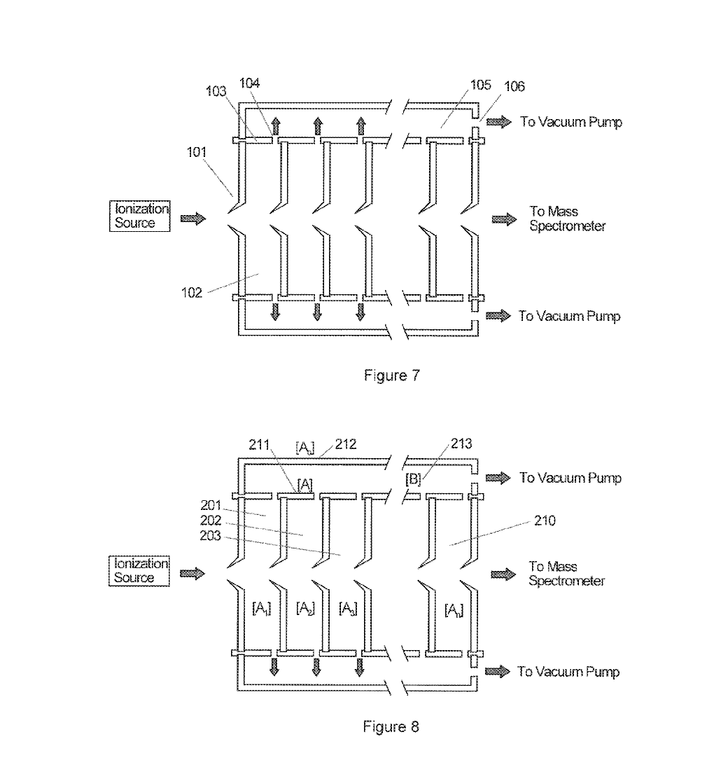

FIG. 7 is a schematic illustration of a generalized arrangement of a skimmer-electrode array according to an embodiment of the invention;

FIG. 8 is a schematic illustration of a generalized arrangement of a skimmer-electrode array according to an embodiment of the invention;

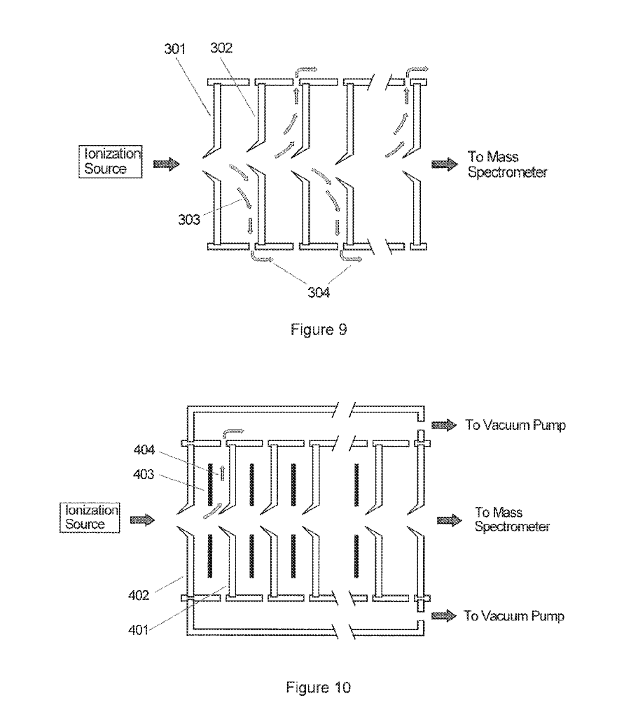

FIG. 9 is a schematic illustration of a generalized arrangement of an array designed with off-axis skimmer-electrodes according to an embodiment of the invention;

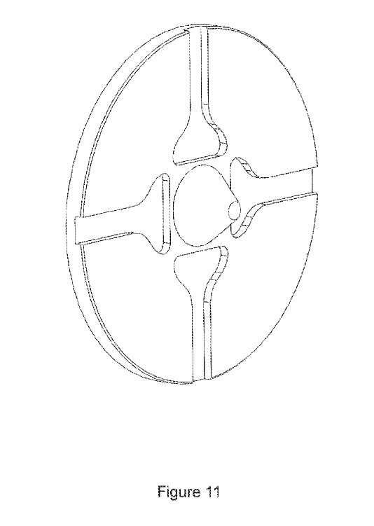

FIG. 10 is a schematic illustration of a generalized arrangement of an array equipped with focusing electrodes to collimate the ions and simultaneously channel the flow.

FIG. 11 is a schematic illustration of a skimmer (which may also serve as an electrode) machined with slots extending radially outwards to collect and direct the gas toward respective pressure exhaust openings.

An illustrative example of an embodiment is described with reference to FIG. 7. A skimmer-shaped electrode 101 is positioned at the entrance of the array to sample ions produced in the ionization source. Ions are preferably produced by electrospray ionization although other ionization methods readily apparent to those skilled in the art can also be employed. A proportion of an electrospray plume of charged droplets is directed towards or orthogonal to the first skimmer electrode 101 with a circular inlet aperture or ion inlet opening that may greater than 2 mm in diameter. A series of similarly shaped skimmer electrodes is positioned further downstream using insulating rings 103. Region 102 established between the first two skimmer-electrodes defines the pressure control chamber volume which is partially evacuated through a series of pressure exhaust openings or orifices 104 arranged symmetrically on the first insulating ring 103. Region 102 is therefore in fluid communication with the pumping line 105 connected to a vacuum pump through port 106.

The gas load presented to the second skimmer electrode is reduced by an amount equivalent to the amount of mass flow rate subtracted by the suctioning action of orifices 104 while pressure in the second region or second pressure-control chamber established between the second and third skimmer electrodes positioned by the second insulating ring is lower. A second set of orifices on the second insulating ring removes part of the remaining gas load to reduce pressure in the third region of the array further. Pressure is therefore reduced progressively from the entrance to the exit of the array thus permitting the use of wide aperture sizes to be employed as a means to enhance ion conductance. Pressure levels in each of the regions established between neighbouring skimmer electrodes is controlled by adjusting the dimensions of the skimmer aperture sizes and the dimensions of the orifices within insulating rings 103 used for pumping gas. Electrostatic focusing can be employed by application of appropriate DC potentials to the skimmer electrodes to focus ions in-through the apertures with high transmission efficiency. The entire array is preferably operated at elevated temperature to promote desolvation of charged droplets.

The skimmer array of FIG. 7 can form an integral part of a mass spectrometer interface where the final stage or region of the array is operated at a pressure of approximately 1 mbar. Subsequent vacuum regions equipped with standard RF ion optical elements typical to those employed in modern mass spectrometers and operated at pressure below 1 mbar can be connected at the far end of the array. In another preferred embodiment the final stage is maintained at an elevated pressure, for example at a pressure of 100 mbar, and the array is coupled to the standard inlet of a mass spectrometer equipped with conventional ion optical systems, for example RF ion optical devices such as the ion funnel or other types of RF ion guides devices operated at approximately 10 mbar and readily known to those skilled in the art. In this preferred embodiment the gas load presented to the entrance of the 10 mbar vacuum region is reduced considerably compared to existing interface designs where pressure is reduced from 1 bar in a single step, therefore the dimensions of the inlet can be increased significantly.

FIG. 7. is a schematic illustration of a generalized arrangement of an atmospheric pressure mass spectrometer interface comprising of a skimmer-electrode array designed to reduce pressure from the ionization source pressure to a lower pressure level in a progressive manner whilst ion transmission is enhanced compared to existing interface technology.

A method for the parameterization of the device in order to specify the dimensions of the apparatus is made with reference to FIG. 8. In this preferred embodiment the apparatus consists of a number of consecutive skimmers and ring spacers forming successive regions 201, 202, 203 and 210 designated with [A₁], [A₂], [A₃] and [Aₙ] respectively. An array design with additional stages between regions 203 and 210 can be implemented but only four regions are shown for simplicity. The skimmer electrodes and ring spacers are shaped into a primary conduit 211 designated with [A] with a predetermined diameter. A secondary conduit 212 designated with [Aₒ] is arranged coaxially and externally to the primary conduit 211 to produce an inner gap, which defines the pumping line 213 designated with [B]. This is the lowest pressure region evacuated using a vacuum pump. All regions 201, 202, 203 and up to the final stage here designated with 210 are in communication with the pumping line 213 through a series of orifices on the insulating ring spacers, similar to the orifices 104 presented in FIG. 7. The method disclosed herein is concerned with the determination of the internal radius of the orifices that must be employed in order to obtain a desired progressive reduction in pressure for an array configuration with a predetermined number of stages.

For the following calculation procedure region 201 will be referred to as [A₁], region 202 as [A₂] and so forth up to the final stage designated with [Aₙ]. Pressure in region [B] is always lower than the lowest pressure in region [Aₙ], and in case of sonic conditions (choked flow) established through the pressure exhaust openings at least by a fraction ½. For the parameterization method presented the requirement is that sonic conditions are always established at the exit of each opening (the mean value of the Mach number at the exit of each aperture is always equal to 1.0, which means that a chocked flow is formed). Although the parameterization method disclosed is concerned with the formation of chocked flow conditions at the orifices used for pumping gas it is by no means limited to such. Other parameterization procedures can be devised readily apparent to those skilled in the art, for example different array configurations are envisaged where the flow through the orifices on the insulating rings is not chocked and/or the pumping line [B] is further sub-divided into regions which may be individually connected to one or more pumps, and each region in communication with only a fraction of the skimmer array through the corresponding orifices on the ring spacers.

For chocked flow conditions the internal radius of each of the orifices is computed by defining (a) the mass flow rate m, that is desired to be subtracted from each region [Aᵢ], i=1, . . . , n, (b) the average static pressure Pᵢ in each region [Aᵢ], i=1, . . . , n, (c) the average total pressure Pₜ, in each region [A], i=1, . . . , n, (d) the average total temperature Tₜᵢ in each region [Aᵢ], i=1, . . . , n, and finally (e) the number of orifices Cᵢ where i=1, . . . , n, distributed circumferentially on each of the ring spacers connecting each region with the pumping line region [B].

The following definitions are introduced for conciseness. Here n refers to the number of the consecutive regions, M is the mach number, R is the gas constant, y is the ratio of specific heats of the gas (y=Cₚ/Cᵥ) where Cₚ is the heat capacity at constant pressure and Cᵥ is the heat capacity at constant volume. The speed of sound α_{ci}, the gas density ρ_{ci} and the average static temperature T_{ci} are determined at the exit of the orifices. Tₜᵢ is the average total temperature in each region [Aᵢ]. The average total pressure at the exit of each orifice is P_{cti} and P_{ci} is the average static pressure for each region [Aᵢ]. A coefficient C_{pl,i} to account for the total pressure losses through the orifices is also introduced with a value of 0.99. Finally, the mass flow rate to be subtracted from each region [Aᵢ] is denoted with mᵢ. The number of openings Cᵢ in each region [Aᵢ] have identical geometric characteristics, but may differ to those in other regions.

We then define the function for the Mach number:

$$f ( M ) = \frac{2}{[ ( γ - 1 ) {M}^{2} + 2 ]}$$

For choked flow conditions the value of the Mach number is unity (M=1) and the expression reduces to:

$$f ( M ) = \frac{2}{[ ( γ - 1 ) + 2 ]}$$

Then assuming perfect gas conditions and one-dimensional flow inside each orifice the following computations can be used in each region [Aᵢ]. The average total temperature at the exit of the orifice is set equal to the average total temperature Tₜᵢ of the upstream region [Aᵢ].

The average static temperature Tᵢ, the average total pressure P_{cti} and the average static pressure P_{ci} at the exit of each orifice are related respectively as:

$${T}_{ci} = {T}_{ti} f ( M ) {P}_{cti} = {P}_{ti} {C}_{pti}$$

$${P}_{ci} = {P}_{cti} {f ( M )}^{\frac{γ}{γ - 1}}$$

The average gas density is then calculated using the perfect gas law as follows:

$${ρ}_{ci} = \frac{{P}_{ci}}{{RT}_{ci}}$$

and the average speed of sound at the exit of each orifice is given by:

α_{ci}=\sqrt{γRT_{ci}}

The total cross sectional area for all the orifices arranged circumferentially on each of the ring spacers positioned in regions [Aᵢ] is then given by:

$${E}_{i} = \frac{{m}_{i}}{{ρ}_{ci} {α}_{ci}}$$

It follows that the radius R_{ci} for each of the orifices can be calculated using the following expression:

$${R}_{ci} = \sqrt{\frac{{E}_{i}}{{C}_{i} π}}$$

In the first preferred embodiment discussed using FIG. 7 and the parameterization method presented with reference to FIG. 8 a common axis is shared between the skimmer electrodes. It is also desirable to design an array where skimmers are progressively displaced off-axis to re-direct a greater portion of the gas flow toward the pumping orifices and into the pumping line to reduce the gas load presented to the apertures further downstream. Reducing the gas load to the skimmer apertures allows for reducing the number of skimmers employed and/or allows for a reduced spacing between skimmers and/or increasing the size of the apertures to enhance ion transmission. FIG. 9 shows an illustrative example where the first 301 and second 302 skimmers are arranged with an offset in the radial direction and an increased portion of the gas flow, indicated by arrows 303 is directed toward the pumping line 304. Side-ways subtraction of a proportion of the gas load can also be achieved by shaping the skimmer electrodes appropriately to help channel the gas toward the pumping line.

This effect could alternatively or additionally be achieved by other methods of displacing the gas, for example arranging the skimmers along a curved path, or introducing an inclination between skimmers.

With reference to the off-set design shown in FIG. 9, ions can be maintained near the ion optical axis by compensating electrostatic potentials applied to the skimmer electrodes. Deflection and focusing fields can also be used to counter-act the force on the ions due to the gas flow field. Mass discrimination effects in terms of differences in ion mobility may be minimised by ensuring that the aperture displacement is small, of the order of a few mm down a fraction of a millimetre.

FIG. 9 is a schematic illustration of a generalized arrangement of an array designed with off-axis skimmer-electrodes.

Skimmer apertures can be reduced in size progressively to further reduce the gas load at the inlet of the mass spectrometer. In other embodiments aperture sizes are uniform throughout the array or can be increased with distance. The actual aperture sizes can be carefully selected by taking into consideration the dimensions of the orifices on the ring spacers connecting the skimmer array to the pumping line. Here too the final pressure presented at the inlet of the mass spectrometer may range from a fraction of an atmosphere to a few mbar. Also the device can be operated at elevated temperatures to promote desolvation of charged droplets (or prevent re-clustering of previously desolvated ions) produced by electrospray ionization or other types of atmospheric pressure ionization sources.

Auxiliary gas flows can be envisaged to enhance ion transmission, for example a jet of gas introduced coaxially to the electrospray nebulizer gas to direct the entire spray into the apparatus, or a counter gas flow to support redirection of gas flow toward the pumping line. Electrodes additional to the skimmer electrodes are desirable for providing electrostatic focusing and collimation of ions more effectively. FIG. 10 shows the focusing electrode 403 positioned between the first 401 and second 402 skimmers to form an electrostatic lens controlled by adjusting the potential applied. It is also preferable to machine the rear side of the focusing electrodes to form slots extending radially outwards and aligned with the orifices on the ring spacers.

FIG. 10 is a schematic illustration of a generalized arrangement of an array equipped with focusing electrodes to collimate the ions and simultaneously channel the gas flow. Electrode shapes departing from the standard skimmer-based coaxial design described so far may equally be used. For example electrodes can be machined flat or take forms where the coaxial symmetry is broken to include channels for the gas to flow outwardly. The thickness of the electrodes can also be varied substantially to affect conductance. The apertures can also be tapered to shape the gas jets discharging into each of the consecutive regions of the apparatus.

An example of a skimmer shaped electrode machined to form channels to direct the deflected portion of the gas outwardly to the pressure exhaust openings is shown in FIG. 11. The skimmer 101 comprises a circular disk the front face of which bears a frusto-conical projection 530 the top of which presents an ion inlet opening 520 for a given pressure-control chamber, for receiving ions entrained within a flow of gas. Four gas guides (500, 510) are arranged symmetrically radially around the frustum 530. Each gas guide comprises a radial channel formed within the front face and extending generally linearly from a proximal end 500 adjacent to a base part of the frustum, to a distal open end 510 at the peripheral edge of the disk 101. The proximal end of the channel defines gas capture region in which the channel is wider than the distal end. This assists in capturing a greater proportion of gas deflected by the frustum 530. The width of the channel decreases gradually (tapers) along a part of the length of the channel extending away from the gas capture region in the direction towards the distal end such that the width of the channel remains substantially constant towards and at the distal end. The depth of each gas guide is substantially constant along the width and length of the channel. In use, gas deflected by the frustum, which does not pass through the inlet opening 520, is deflected towards a gas capture region 500 of one or more gas guides, where it is channelled along the channel of the gas guide(s) towards a pressure exhaust opening 104. The distal ends of the channels of the gas guides are preferably positioned in register with a respective pressure exhaust opening to permit efficient output of the guided gas.

The discussion included in this Annex is intended to serve as a basic description. Although the present has been described in accordance with the various embodiments shown and discussed in some detail, one of ordinary skill in the art will readily recognize that there could be variations to the embodiments and those variations would be within the scope and spirit of the present invention. The reader should be aware that the specific discussion may not explicitly describe all embodiments possible; many alternatives are implicit. For instance the number of regions the interface apparatus is comprised of, the range of operating pressures, the nature of the electric fields, DC or RF or combinations thereof, including the shape of the electrodes and the design of the pumping line together with the off-set configuration and broken symmetry electrodes can all be combined and varied to a great extent.

1-20. (canceled)

21. An ion transfer apparatus for transferring ions from a first pressure controlled chamber at a first pressure, which first pressure is lower than 10000 Pa, along a path to an adjacent second pressure controlled chamber at a second pressure that is lower than the first pressure, the ion transfer apparatus including:
the first pressure controlled chamber and the second pressure controlled chamber, wherein each pressure controlled chamber includes an ion inlet opening for receiving ions on the path and an ion outlet opening for outputting the ions on the path, wherein the ion outlet opening of the first pressure controlled chamber is in flow communication with the ion inlet opening of a the second pressure controlled chamber; and
an RF focusing device configured to focus ions towards the path, the RF focusing device including a plurality of RF focusing electrodes, wherein each RF focusing electrode of the RF focusing device is configured to receive an RF voltage so as to produce an electric field that acts to focus ions towards the path, wherein each RF focusing electrode of the RF focusing device has a shape that extends circumferentially around the path;
wherein the first and second pressure controlled chambers each include RF focusing electrodes of the RF focusing device;
wherein each RF focusing electrode of the RF focusing device has a thickness in the direction of the path and a thickness in a direction radial to the path that is less than a distance separating the RF focusing electrode from an adjacent RF focusing electrode of the RF focusing device.

22. An ion transfer apparatus as set out in claim 21, wherein for each RF focusing electrode of the RF focusing device, the thickness of the RF focusing electrode in the direction of the path and the thickness of the RF focusing electrode in a direction radial to the path is less than half of a distance separating the RF focusing electrode from an adjacent RF focusing electrode of the RF focusing device.

23. An ion transfer apparatus as set out in claim 21, wherein for each RF focusing electrode of the RF focusing device, the RF focusing electrode is separated from an adjacent RF focusing electrode of the RF focusing device by a distance that is between 3 and 7 times the thickness of the RF focusing electrode in the direction of the path.

24. An ion transfer apparatus as set out in claim 21, wherein for each RF focusing electrode of the RF focusing device, the thickness of the RF focusing electrode in a direction radial to the path is between 0.5 and 1.5 times the thickness of the RF focusing electrode in the direction of the path.

25. An ion transfer apparatus as set out in claim 21, wherein, for each RF focusing electrode of the RF focusing device, the internal width of an aperture of the RF focusing electrode at its maximum extent is between 1.5 and 10 times a distance separating the RF focusing electrode from an adjacent RF focusing electrode of the RF focusing device.

26. An ion transfer apparatus as set out in claim 21 wherein, for each RF focusing electrode of the RF focusing device, an aperture of the RF focusing electrode has an internal width that is dependent on the position of the RF focusing electrode along the path such that the internal widths of the RF focusing electrodes reduce progressively with position along at least a portion of the path.

27. An ion transfer apparatus as set out in claim 21, wherein for each RF focusing electrode of the RF focusing device, the RF focusing electrode is part of a metal sheet.

28. An ion transfer apparatus as set out in claim 27, wherein each metal sheet includes an outer support structure connected to the RF focusing electrode that is part of the metal sheet via at least one supporting limb.

29. An ion transfer apparatus as set out in claim 28, wherein, for each metal sheet, the/each supporting limb connected to the RF focusing electrode that is part of the metal sheet has a thickness in a direction circumferential to the path that is no more than 3 times the thickness of the RF focusing electrode in the direction of the path.

30. An ion transfer apparatus as set out in claim 28, wherein, for each metal sheet, a distance from the outer support structure to the RF focusing electrode that is part of the metal sheet is, at its minimum extent, greater than an internal width of an aperture of the RF focusing electrode at its maximum extent.

31. An ion transfer apparatus as set out in claim 21, wherein if the second chamber has a pressure of more than 1000 Pa, the ratio of the pressure in the first chamber to the pressure in the second chamber is less than 2.

32. An ion transfer apparatus as set out in claim 21, wherein if the second chamber has a pressure of less than 1000 Pa, the ratio of the pressure in the first chamber to the pressure in the second chamber is less than 5.

33. An ion transfer apparatus as set out in claim 21, wherein the path in the first pressure controlled chamber is inclined relative to the path in the second pressure controlled chamber.

34. An ion transfer apparatus as set out in claim 21, wherein the ion transfer device includes more than two pressure controlled chambers that each include RF focusing electrodes of the RF focusing device.

35. An ion transfer apparatus as set out in claim 21, wherein the ion transfer device is for transferring ions from an ion mobility spectrometry device or a differential mobility spectrometry device at an IMS/DMS pressure, along a path towards a mass analyser at a mass analyser pressure that is lower than the IMS/DMS pressure.

36. An ion transfer apparatus as set out in claim 21, wherein:
the ion transfer apparatus is for transferring ions from an ion source at an ion source pressure, which ion source pressure is greater than 500 mbar, along a path towards a mass analyser at a mass analyser pressure that is lower than the ion source pressure.

37. An ion transfer apparatus as set out in claim 21, wherein:
the ion transfer device includes a plurality of pressure controlled chambers, wherein each pressure controlled chamber in the ion transfer apparatus includes an ion inlet opening for receiving ions from the ion source on the path and an ion outlet opening for outputting the ions on the path, wherein the first and second pressure controlled chambers are included in the plurality of pressure controlled chambers;
the plurality of pressure controlled chambers are arranged in succession along the path from an initial pressure controlled chamber to a final pressure controlled chamber, wherein an ion outlet opening of each pressure controlled chamber other than the final pressure controlled chamber is in flow communication with the ion inlet opening of a successive adjacent pressure controlled chamber;
the ion transfer apparatus is configured to have, in use, at least one pair of adjacent pressure controlled chambers for which a ratio of pressure in an upstream pressure controlled chamber to pressure in a downstream pressure controlled chamber is set such that there is substantially subsonic gas flow in the downstream pressure controlled chamber.

38. An ion transfer apparatus as set out in claim 37, wherein:
a subset of the pressure controlled chambers each include one or more DC focusing electrodes configured to receive one or more DC voltages so as to produce an electric field that acts to focus ions towards the path;
a subset of the pressure controlled chambers each include one or more RF focusing electrodes, each RF focusing electrode being configured to receive an RF voltage so as to produce an electric field that acts to focus ions towards the path.

39. A mass spectrometer including:
an ion source at an ion source pressure;
a mass analyser at a mass analyser pressure;
an ion transfer apparatus for transferring ions from a first pressure controlled chamber at a first pressure, which first pressure is lower than 10000 Pa, along a path to an adjacent second pressure controlled chamber at a second pressure that is lower than the first pressure, the ion transfer apparatus including:
the first pressure controlled chamber and the second pressure controlled chamber, wherein each pressure controlled chamber includes an ion inlet opening for receiving ions on the path and an ion outlet opening for outputting the ions on the path, wherein the ion outlet opening of the first pressure controlled chamber is in flow communication with the ion inlet opening of a the second pressure controlled chamber; and
an RF focusing device configured to focus ions towards the path, the RF focusing device including a plurality of RF focusing electrodes, wherein each RF focusing electrode of the RF focusing device is configured to receive an RF voltage so as to produce an electric field that acts to focus ions towards the path, wherein each RF focusing electrode of the RF focusing device has a shape that extends circumferentially around the path;
wherein the first and second pressure controlled chambers each include RF focusing electrodes of the RF focusing device;
wherein each RF focusing electrode of the RF focusing device has a thickness in the direction of the path and a thickness in a direction radial to the path that is less than a distance separating the RF focusing electrode from an adjacent RF focusing electrode of the RF focusing device.

40. A method of making an ion transfer apparatus for transferring ions from a first pressure controlled chamber at a first pressure, which first pressure is lower than 10000 Pa, along a path to an adjacent second pressure controlled chamber at a second pressure that is lower than the first pressure, the ion transfer apparatus including:
the first pressure controlled chamber and the second pressure controlled chamber, wherein each pressure controlled chamber includes an ion inlet opening for receiving ions on the path and an ion outlet opening for outputting the ions on the path, wherein the ion outlet opening of the first pressure controlled chamber is in flow communication with the ion inlet opening of a the second pressure controlled chamber; and
an RF focusing device configured to focus ions towards the path, the RF focusing device including a plurality of RF focusing electrodes, wherein each RF focusing electrode of the RF focusing device is configured to receive an RF voltage so as to produce an electric field that acts to focus ions towards the path, wherein each RF focusing electrode of the RF focusing device has a shape that extends circumferentially around the path;
wherein the first and second pressure controlled chambers each include RF focusing electrodes of the RF focusing device;
wherein each RF focusing electrode of the RF focusing device has a thickness in the direction of the path and a thickness in a direction radial to the path that is less than a distance separating the RF focusing electrode from an adjacent RF focusing electrode of the RF focusing device;
wherein the method includes forming each RF focusing electrode of the RF focusing device from a metal sheet by chemical etching.
